(19) United States
(12) Patent Application Publication
(10) Pub. No.: US 2025/0079736 A1
(43) Pub. Date: Mar. 6, 2025

(54) ELECTRIC CONNECTOR AND CONNECTOR ASSEMBLY

(71) Applicant: HIROSE ELECTRIC CO., LTD., Kanagawa (JP)

(72) Inventor: Kouhei ODA, Kanagawa (JP)

(21) Appl. No.: 18/785,780

(22) Filed: Jul. 26, 2024

(30) Foreign Application Priority Data
Aug. 28, 2023 (JP) 2023-137935

(51) Int. Cl. H01R 12/71; H01R 12/72; H01R 13/6471

(52) U.S. Cl. CPC H01R 12/718; H01R 12/724; H01R 13/6471

(57) ABSTRACT

Provided is an electric connector including a first terminal; a second terminal; and a housing, in which the first terminal extends in a short-side direction, and the second terminal extends in a long-side direction; a pair of the first terminals is provided so as to face each other in the short-side direction and the pairs of the first terminals are arranged along the long-side direction; a pair of the second terminals is provided so as to face each other in the long-side direction; the housing has a pair of wall portions, and the pair of wall portions holds the pairs of the first terminals; and the pair of the second terminals is provided between the pairs of the first terminals and between the pair of wall portions in the short-side direction, and is provided so as to sandwich the pairs of the first terminals in the long-side direction.

### CROSS-REFERENCE TO RELATED APPLICATION

This application claims priority from Japanese Patent Application No. 2023-137935 filed with the Japan Patent Office on Aug. 28, 2023, the entire content of which is hereby incorporated by reference.

### BACKGROUND

### 1. Technical Field

The present disclosure relates to an electric connector and a connector assembly.

### 2. Related Art

Conventionally, there have been known various techniques related to an electric connector for, e.g., connection of a printed circuit board or a flexible flat cable, which has a terminal and a housing. For example, JP-A-2020-184459 discloses an electric connector including a plurality of terminals arranged at equal intervals along a long-side direction and a housing having side wall portions extending in the long-side direction to hold the plurality of terminals. In the electric connector of JP-A-2020-184459, the plurality of terminals is provided in a pair so as to symmetrically face each other in a short-side direction, and the side wall portions are provided in a pair to hold the pair of terminals. Further, the electric connector also includes a pair of reinforcing metal fittings arranged apart from each other so as to face each other in the long-side direction with the pair of terminals interposed therebetween.

### SUMMARY

An electric connector according to an embodiment of the present disclosure is an electric connector including a first terminal; a second terminal; and a housing, in which the first terminal is formed so as to extend in a short-side direction of the electric connector, and the second terminal is formed so as to extend in a long-side direction of the electric connector; a pair of the first terminals is provided so as to face each other in the short-side direction and the pairs of the first terminals are arranged along the long-side direction; a pair of the second terminals is provided so as to face each other in the long-side direction; the housing has a pair of wall portions, and the pair of wall portions extends in the long-side direction, faces each other in the short-side direction, and holds the pairs of the first terminals; and the pair of the second terminals is provided between the pairs of the first terminals and between the pair of wall portions in the short-side direction, and is provided so as to sandwich the pairs of the first terminals in the long-side direction.

### BRIEF DESCRIPTION OF THE DRAWINGS

FIG. 1 is a perspective view of a connector assembly according to an embodiment of the present disclosure in a state before fitting;

FIG. 2 is an exploded perspective view of a receptacle connector according to the embodiment of the present disclosure;

FIGS. 3A and 3B are enlarged views of the vicinity of one reinforcing metal fitting in the receptacle connector according to the embodiment of the present disclosure, FIG. 3A being an enlarged perspective view and FIG. 3B being an enlarged top view;

FIG. 4 is an exploded perspective view of a plug connector according to the embodiment of the present disclosure;

FIG. 5 is a side view of the connector assembly according to the embodiment of the present disclosure in the state before fitting;

FIG. 6 is a sectional view of the connector assembly according to the embodiment of the present disclosure as viewed along a VI-VI line in FIG. 5; and

FIG. 7 is a sectional view of the connector assembly according to the embodiment of the present disclosure as viewed along a VII-VII line in FIG. 6.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In recent years, electronic components have been mounted on a printed circuit board with a higher density due to, e.g., size reduction in electronic equipment such as a smartphone or a mobile phone and function enhancement thereof. Accordingly, size reduction in the electric connector itself has been demanded. Moreover, for example, in order to handle many types of data, there has also been demanded an increase in the number of terminal pins such as signal terminals (terminals for transmitting predetermined signals) applied to the electric connector. In a case where only the latter demand is focused, the number of terminal pins can be easily increased by a size increase in the electric connector. However, in this case, the former demand cannot be satisfied. For this reason, there has been demanded an increase in the number of terminal pins without a size increase in the electric connector.

Note that the electric connector described in JP-A-2020-184459 only uses the metal fitting portions provided in the pair of side wall portions of the housing as terminals, and there is still room for improvement in increasing the number of terminal pins.

The present disclosure has been made in order to solve the above-described problems, and one object thereof is to properly increase the number of terminal pins in the electric connector.

An electric connector according to one embodiment of the present disclosure is an electric connector including a first terminal; a second terminal; and a housing, in which the first terminal is formed so as to extend in a short-side direction of the electric connector, and the second terminal is formed so as to extend in a long-side direction of the electric connector; a pair of the first terminals is provided so as to face each other in the short-side direction and the pairs of the first terminals are arranged along the long-side direction; a pair of the second terminals is provided so as to face each other in the long-side direction; the housing has a pair of wall portions, and the pair of wall portions extends in the long-side direction, faces each other in the short-side direction, and holds the pairs of the first terminals; and the pair of the second terminals is provided between the pairs of the first terminals and between the pair of wall portions in the short-side direction, and is provided so as to sandwich the pairs of the first terminals in the long-side direction.

According to the present disclosure, the number of terminal pins can be properly increased without a size increase in the electric connector.

Hereinafter, an embodiment of the present disclosure will be described with reference to the drawings. Note that in all figures for describing the embodiment, the same reference numerals are basically used to represent the same members and repeated description thereof may be omitted.

### Configurations of Connector Assembly and Electric Connector

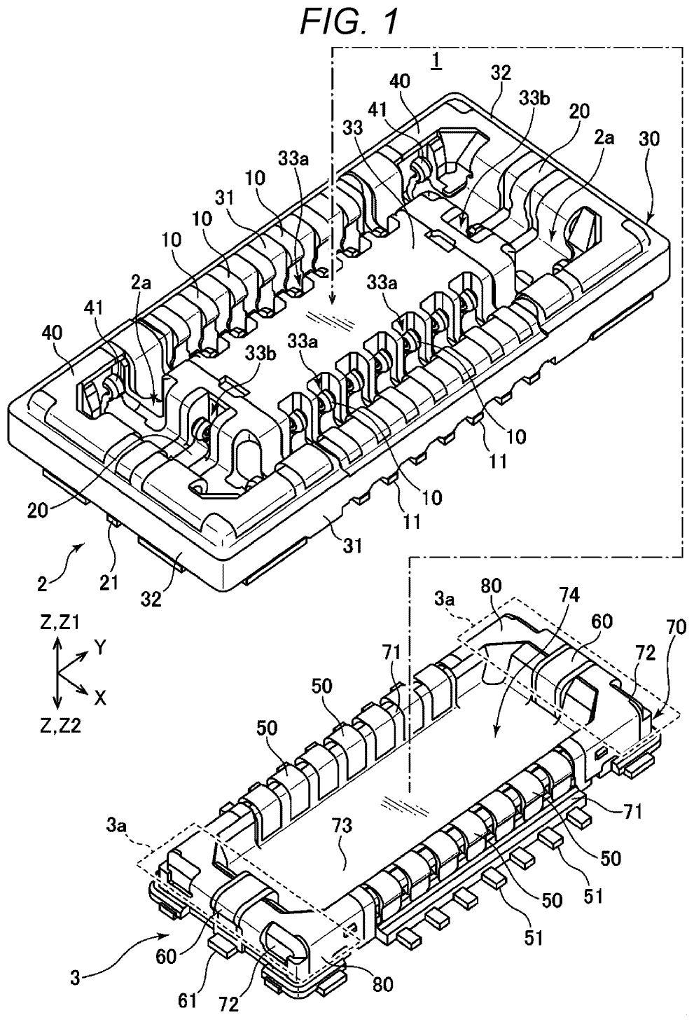

First, the configuration of a connector assembly according to the embodiment of the present disclosure will be described with reference to FIG. 1. FIG. 1 is a perspective view of the connector assembly according to the present embodiment in a non-fitting state.

As shown in FIG. 1, a connector assembly 1 according to the present embodiment has a receptacle connector 2 and a plug connector 3, and the receptacle connector 2 and the plug connector 3 are formed to be fitted in each other. Hereinafter, when the receptacle connector 2 and the plug connector 3 are not distinguished from each other, these connectors may be referred to as a “connector(s) 2, 3” or merely as a “connector(s)”. The connector 2, 3 is mounted on a board (not shown) which is a mount target to be electrically connected, such as a printed circuit board. For both the receptacle connector 2 and the plug connector 3 in FIG. 1, a fitting side (fitting surface) is a front side, and a board mount side is a back side. Moreover, the connector 2, 3 can be used as an internal component in small electronic equipment such as a mobile phone, a smartphone, a digital camera, or a laptop computer. Note that the receptacle connector 2 is one example of an “electric connector” in the present disclosure. The receptacle connector 2 is also mountable on various mount targets, such as a flexible flat cable, other than the board such as the printed circuit board, but an example where the receptacle connector 2 is mounted on the board will be described below.

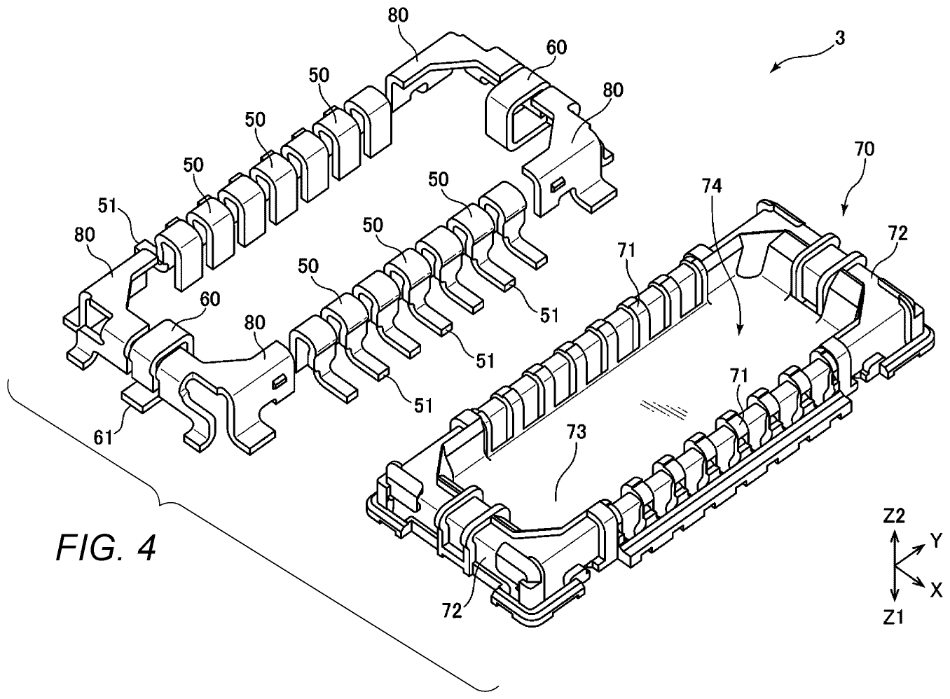

In FIG. 1 (the same also applies to other figures), the short-side direction (width direction) of the connector is shown as “X” (equivalent to a “lateral direction” in the present disclosure), the long-side direction (depth direction) of the connector is shown as “Y” (equivalent to a “longitudinal direction” in the present disclosure), and the fitting direction (upper-lower direction) of the connector is shown as “Z.” In other words, an axis along the short-side direction is defined as an X-axis, an axis along the long-side direction is defined as a Y-axis, and an axis along the fitting direction is defined as a Z-axis. Moreover, in the present specification, in the fitting direction Z, the side of a certain connector on which the certain connector receives a partner connector will be defined as “upper” or “front,” and the side on which the certain connector is attached to the board will be defined as “lower” or “back.” Specifically, for the receptacle connector 2, a direction indicated by “Z1” in the fitting direction Z is equivalent to an “upper direction,” and a direction indicated by “Z2” in the fitting direction Z is equivalent to a “lower direction.” On the other hand, FIG. 1 shows, for the sake of convenience in description, a state in which the plug connector 3 is upside down in order to fit the plug connector 3 in the receptacle connector 2, and therefore, the direction indicated by “Z2” is actually equivalent to the “upper direction” and the direction indicated by “Z1” is actually equivalent to the “lower direction” (i.e., when the plug connector 3 is in a state of being fittable in the receptacle connector 2) (also see FIGS. 4 to 7 described later).

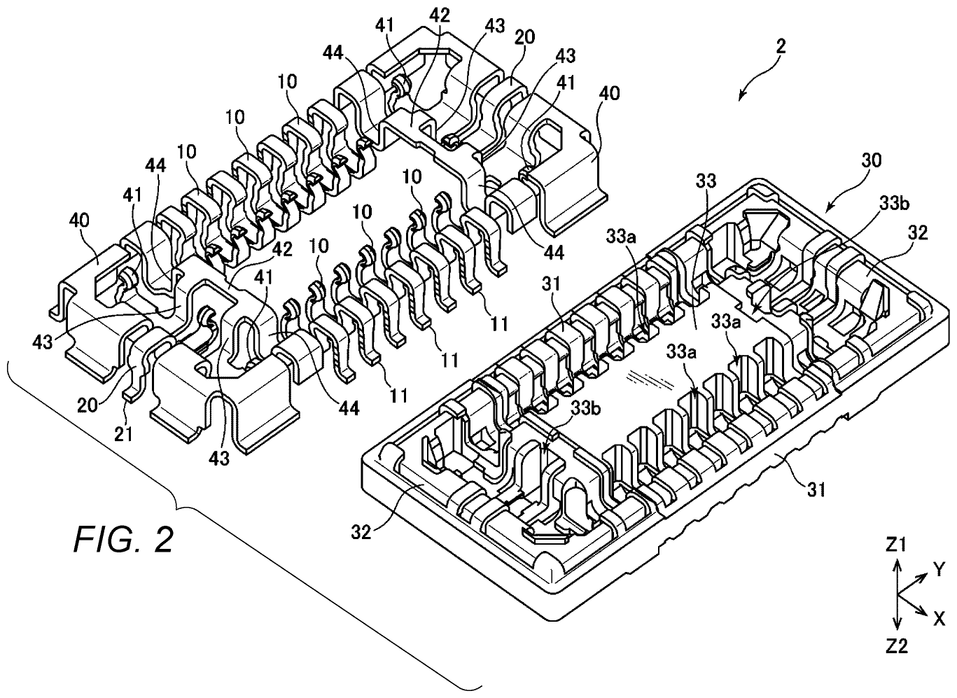

Next, the receptacle connector 2 according to the present embodiment will be specifically described with reference to not only FIG. 1 but also FIG. 2. FIG. 2 is an exploded perspective view of the receptacle connector 2 according to the present embodiment.

As shown in FIGS. 1 and 2, the receptacle connector 2 mainly has a plurality of first terminals 10 and a plurality of second terminals 20, a reinforcing metal fitting 40, and a housing 30 holding the first terminals 10, the second terminals 20, and the reinforcing metal fitting 40. Each of the first terminals 10 and the second terminals 20 is formed as a signal terminal for transmitting a predetermined signal.

The housing 30 has a pair of long-side wall portions 31, a pair of short-side wall portions 32, and a fitting raised portion 33. The pair of long-side wall portions 31 extends in the long-side direction Y, and is arranged apart from each other so as to face each other in the short-side direction X. The pair of short-side wall portions 32 extends in the short-side direction X, and is arranged apart from each other so as to face each other in the long-side direction Y.

The fitting raised portion 33 to be fitted in the plug connector 3 is in a substantially rectangular shape in plan view (in top view), and is provided in an internal space surrounded by the pair of long-side wall portions 31 and the pair of short-side wall portions 32. The fitting raised portion 33 is provided on the center side of the housing 30 with respect to the pair of long-side wall portions 31 and the pair of short-side wall portions 32. The fitting raised portion 33 is provided so as to protrude in a direction of fitting the receptacle connector 2 in the plug connector 3.

The plurality of first terminals 10 is arranged at equal intervals along the long-side direction Y, and each first terminal 10 is formed so as to extend in the short-side direction X. Moreover, the plurality of first terminals 10 is provided in pairs so as to symmetrically face each other in the short-side direction X, and the pairs of first terminals 10 are held by the pair of long-side wall portions 31 of the housing 30 along the long-side direction Y. The first terminal 10 includes a mount portion 11 at one end in the short-side direction X, specifically at an end portion located so as to face outward of the receptacle connector 2, and at the mount portion 11, is mounted on the board by soldering.

Unlike the first terminal 10 extending in the short-side direction X as described above, the second terminal 20 is formed so as to extend in the long-side direction Y, and the receptacle connector 2 has two second terminals 20. These two second terminals 20 are each held by the pair of short-side wall portions 32. The two second terminals 20 (a pair of second terminals 20) are provided between the pairs of first terminals 10 and between the pair of long-side wall portions 31 in the short-side direction X, and are arranged so as to face each other in the long-side direction Y with the pairs of first terminals 10 interposed therebetween.

As shown in FIG. 1, the two second terminals 20 are arranged outside the pairs of first terminals 10 in the long-side direction Y in the receptacle connector 2. In other words, one of the pair of second terminals 20 is disposed outside one ends of the pairs of first terminals 10 in the long-side direction Y in the receptacle connector 2, and the other second terminal 20 is disposed outside the other ends of the pairs of first terminals 10 in the long-side direction Y in the receptacle connector 2. A distance between the pair of second terminals 20 facing each other in the long-side direction Y is greater than the length of the pairs of first terminals 10 in the long-side direction Y.

At one end (tip end) in the long-side direction Y, specifically at an end portion located so as to face the first terminal 10 side, the second terminal 20 extends to the edge of the fitting raised portion 33 of the housing 30. In addition, the second terminal 20 includes a mount portion 21 at the other end in the long-side direction Y, specifically at an end portion located so as to face outward of the receptacle connector 2, and at the mount portion 21, is mounted on the board by soldering.

The first terminal 10 is formed such that a terminal 50 of the plug connector 3 is receivable (i.e., fittable) by the first terminal 10, and when the terminal 50 is inserted, part of the first terminal 10 is elastically deformed in the short-side direction X. The second terminal 20 is formed such that a terminal 60 of the plug connector 3 is receivable (fittable) by the second terminal 20, and when the terminal 60 is inserted, part of the second terminal 20 is elastically deformed in the long-side direction Y. In this case, the fitting raised portion 33 of the housing 30 has a plurality of spaces 33a for receiving the elastically-deformable portions of the plurality of first terminals 10 and two spaces 33b for receiving the elastically-deformable portions of the two second terminals 20, and when the terminal 50 and terminal 60 of the plug connector 3 are inserted, the first terminal 10 and the second terminal 20 can be displaced in the spaces 33a, 33b of the fitting raised portion 33.

Further, the receptacle connector 2 has a pair of reinforcing metal fittings 40. The pair of reinforcing metal fittings 40 is provided at both ends of the receptacle connector 2 in the long-side direction Y, and extends in the short-side direction X. The pair of reinforcing metal fittings 40 is held by the pair of short-side wall portions 32 provided so as to face each other with the pairs of first terminals 10 interposed therebetween, and is provided so as to surround the second terminals 20.

Each of the pair of reinforcing metal fittings 40 has two third terminals 41 as power terminals provided in the vicinity of both ends in the short-side direction X. These two third terminals 41 are provided in the vicinity of the second terminal 20. Unlike the second terminal 20 extending in the long-side direction Y, the third terminal 41 is formed so as to extend in the short-side direction X.

As shown in FIG. 1, the receptacle connector 2 has, at a portion surrounded by one second terminal 20 and two third terminals 41 provided in the vicinity of such a second terminal 20, a fitting recessed portion 2a provided for receiving a fitting raised portion 3a (portion indicated by a dashed line in FIG. 1) of the plug connector 3 and having a substantially rectangular shape in plan view. The fitting recessed portion 2a is provided so as to be recessed in the direction opposite to the direction of fitting the receptacle connector 2 in the plug connector 3 in the vicinity of the both ends of the receptacle connector 2 in the long-side direction Y. Note that the fitting raised portion 3a of the plug connector 3 is formed by a later-described short-side wall portion 72 (also including the terminal 60 and a reinforcing metal fitting 80).

In the present embodiment, the plurality of third terminals 41 faces each other in the short-side direction X with each of the pair of second terminals 20 interposed therebetween, and is provided apart from each other so as to face each other in the long-side direction Y with the pairs of first terminals 10 interposed therebetween.

In the present embodiment, the receptacle connector 2 has four third terminals 41. The third terminals 41 are each provided on both sides of one of the pair of second terminals 20 and both sides of the other second terminal 20. Moreover, the third terminal 41 provided on each side of one of the pair of second terminals 20 and the third terminal 41 provided on each side of the other second terminal 20 are provided apart from each other so as to face each other in the long-side direction Y with the pairs of first terminals 10 interposed therebetween.

As described later, in the present embodiment, the receptacle connector 2 has two fitting recessed portions 2a. The fitting recessed portion 2a is provided at a portion surrounded by each of the pair of second terminals 20 and the third terminals 41 facing each other in the short-side direction X with each of the pair of second terminals 20 interposed therebetween. The pair of second terminals 20 and the third terminals 41 surrounding the fitting recessed portion are elastically deformable when the receptacle connector 2 and the plug connector 3 are fitted in each other.

In description below, unless otherwise specified, “two third terminals 41” indicate two third terminals 41 provided so as to face each other in the short-side direction X with one or the other one of the pair of second terminals 20 interposed therebetween.

Note that the number of second terminals 20 and the number of third terminals 41 are not limited to those of the example of the present embodiment. The number of second terminals 20 held by each of the pair of short-side wall portions 32 of the receptacle connector 2 is not necessarily one, but may be a plural number. A plurality of third terminals 41 may be arranged on both sides of one or more second terminals 20 in the short-side direction X.

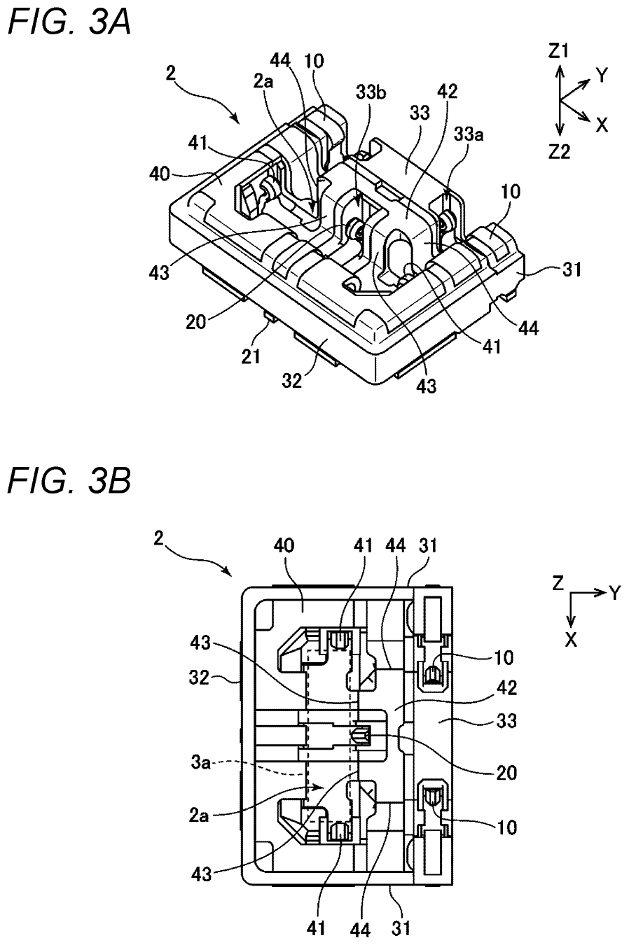

The fitting recessed portion 2a of the receptacle connector 2 will be specifically described with reference to not only FIG. 1 but also FIGS. 3A and 3B. FIG. 3A is an enlarged perspective view of the vicinity of one reinforcing metal fitting 40 in the receptacle connector 2 according to the present embodiment, and FIG. 3B is an enlarged top view of the vicinity of the reinforcing metal fitting 40.

As described above, the receptacle connector 2 has, at the portion surrounded by one second terminal 20 and two third terminals 41, the fitting recessed portion 2a having the substantially rectangular shape in plan view. As shown in FIG. 3B, when the fitting raised portion 3a (indicated by a dashed line in FIG. 3B) of the plug connector 3 is inserted into the fitting recessed portion 2a, the one second terminal 20 and the two third terminals 41 contact the fitting raised portion 3a, specifically contact the three sides of the fitting raised portion 3a, and are elastically deformed.

In this case, part (arm portion) of the second terminal 20 is elastically deformed in the long-side direction Y, and part (arm portions) of the two third terminals 41 is elastically deformed in the short-side direction X. Particularly, the third terminal 41 is elastically deformed in the short-side direction X as in the first terminal 10, but is different from the first terminal 10 in the elastic deformation side in the short-side direction X. More specifically, in the first terminal 10, a portion (arm portion) on the fitting raised portion 33 side, i.e., on the side opposite to the long-side wall portion 31, is elastically deformed in the short-side direction X, whereas in the third terminal 41, a portion (arm portion) on the long-side wall portion 31 side is elastically deformed in the short-side direction X.

As shown in FIGS. 3A and 3B (also see FIG. 2 as necessary), the reinforcing metal fitting 40 has an upper cover portion 42, first side cover portions 43, and second side cover portions 44. The upper cover portion 42 covers the upper surface of both ends of the fitting raised portion 33 of the housing 30 in the long-side direction Y. The first side cover portion 43 covers part (portion on each side of the second terminal 20 in the short-side direction X) of a side surface of the fitting raised portion 33 at the both ends in the long-side direction Y. The second side cover portion 44 covers part (portion in the vicinity of the both ends in the long-side direction Y) of a side surface of the fitting raised portion 33 at the both ends in the short-side direction X.

The reinforcing metal fitting 40 receives the elastically-deformable portion of the second terminal 20 by the upper cover portion 42, the first side cover portions 43, and the second side cover portions 44, and surrounds the space 33b formed in the fitting raised portion 33 of the housing 30. Thus, the space 33b can be protected.

Next, the plug connector 3 according to the present embodiment will be specifically described with reference to not only FIG. 1 but also FIG. 4. FIG. 4 is an exploded perspective view of the plug connector 3 according to the present embodiment.

As shown in FIGS. 1 and 4, the plug connector 3 mainly has the plurality of terminals 50 and the plurality of terminals 60, the reinforcing metal fitting 80, and a housing 70 holding the terminals 50, 60 and the reinforcing metal fitting 80. Each of the terminals 50 and terminals 60 of the plug connector 3 is fitted in a corresponding one of the first terminals 10 and second terminals 20 of the receptacle connector 2. The terminal 50 and the terminal 60 are formed as signal terminals for transmitting predetermined signals.

The housing 70 has a pair of long-side wall portions 71, a pair of short-side wall portions 72, a bottom wall portion 73, and a fitting recessed portion 74. The pair of long-side wall portions 71 extends in the long-side direction Y, and is arranged apart from each other so as to face each other in the short-side direction X. The pair of short-side wall portions 72 extends in the short-side direction X, and is arranged apart from each other so as to face each other in the long-side direction Y. The bottom wall portion 73 extends in the long-side direction Y and the short-side direction X. The fitting recessed portion 74 is provided in an internal space surrounded by the pair of long-side wall portions 71, the pair of short-side wall portions 72, and the bottom wall portion 73 to receive the fitting raised portion 33 of the receptacle connector 2.

The plurality of terminals 50 is arranged at equal intervals along the long-side direction Y, and each terminal 50 is formed so as to extend in the short-side direction X. Moreover, the plurality of terminals 50 is provided in pairs so as to symmetrically face each other in the short-side direction X, and the pairs of terminals 50 are each held by each of the pair of long-side wall portions 71 of the housing 70. The terminal 50 includes a mount portion 51 at one end in the short-side direction X, specifically at an end portion located so as to face outward of the plug connector 3, and at the mount portion 51, is mounted on the board by soldering.

Unlike the terminal 50 extending in the short-side direction X as described above, the terminal 60 is formed so as to extend in the long-side direction Y, and the plug connector 3 has two terminals 60. These two terminals 60 are provided between the pairs of terminals 50 and between the pair of long-side wall portions 71 in the short-side direction X, are arranged so as to face each other in the long-side direction Y with the pairs of terminals 50 interposed therebetween, and are each held by the pair of short-side wall portions 72. The terminal 60 includes a mount portion 61 at one end in the long-side direction Y, specifically at an end portion located so as to face outward of the plug connector 3, and at the mount portion 61, is mounted on the board by soldering.

Note that the receptacle connector 2 is produced by integral molding (typically, insert molding) using a conductive member forming the first terminal 10, the second terminal 20, and the reinforcing metal fitting 40, such as copper alloy, and resin forming the housing 30, such as liquid crystal polymer (LCP). Similarly, the plug connector 3 is also produced by integral molding (typically, insert molding) using a conductive member forming the terminals 50, 60 and the reinforcing metal fitting 80, such as copper alloy, and resin forming the housing 70, such as liquid crystal polymer (LCP).

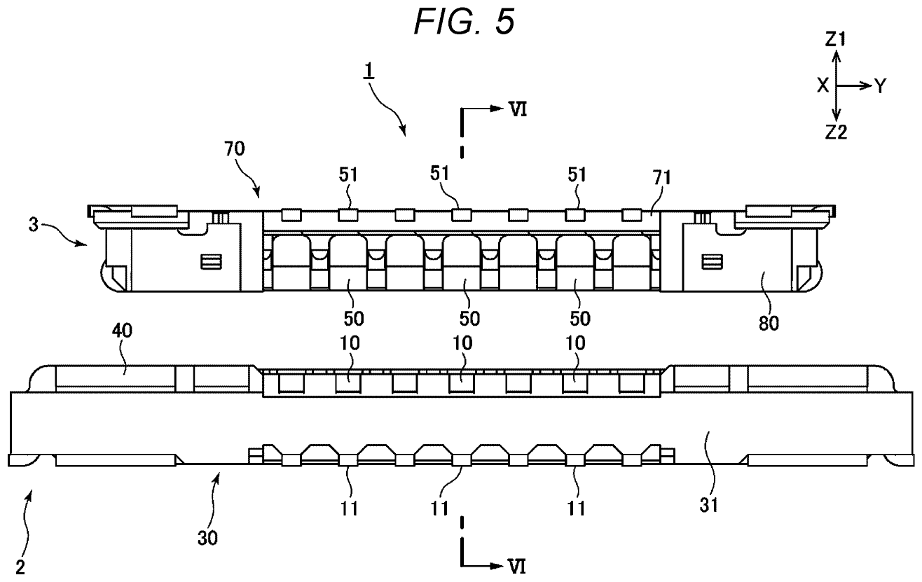

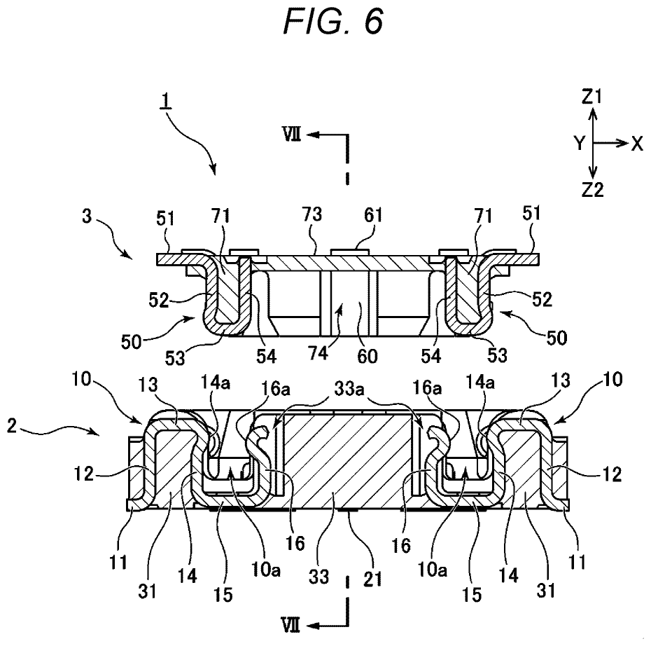

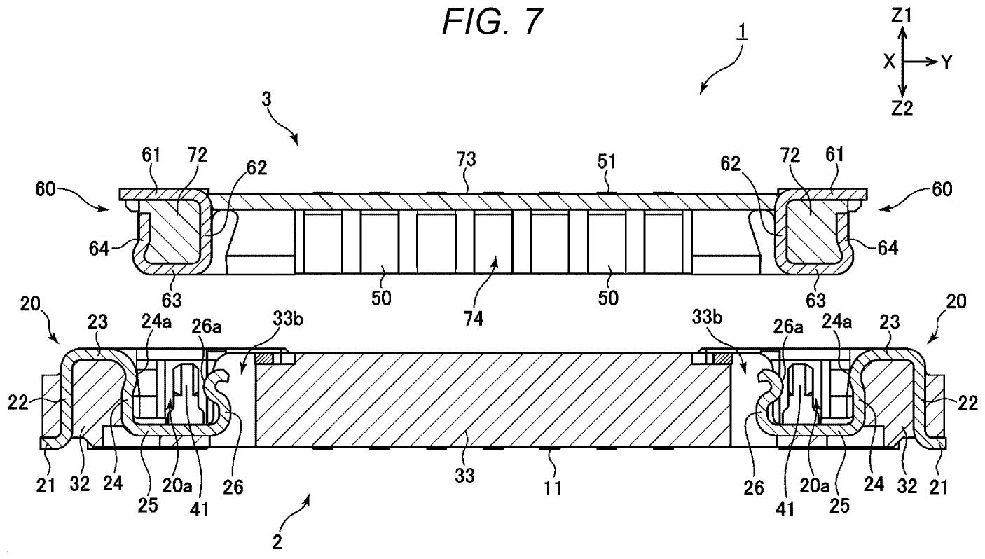

Next, the first terminal 10 and second terminal 20 of the receptacle connector 2 and the terminals 50, 60 of the plug connector 3 according to the present embodiment will be specifically described with reference to FIGS. 5 to 7. FIG. 5 is a side view of the connector assembly 1 according to the present embodiment in a state before fitting as viewed along the short-side direction X. FIG. 6 is a sectional view of the connector assembly 1 according to the present embodiment as viewed along a VI-VI line in FIG. 5. FIG. 7 is a sectional view of the connector assembly 1 according to the present embodiment as viewed along a VII-VII line in FIG. 6.

As shown in FIG. 6, the first terminals 10 of the receptacle connector 2 are provided in a pair so as to symmetrically face each other in the short-side direction X. Each first terminal 10 has leg portions 12, 14 and an arm portion 16 extending in the fitting direction Z and provided apart from each other in this order along the short-side direction X, the mount portion 11 connected to a lower direction Z2-side end portion of the leg portion 12 and extending in the short-side direction X, a coupling portion 13 extending in the short-side direction X and connecting an upper direction Z1-side end portion of the leg portion 12 and an upper direction Z1-side end portion of the leg portion 14 to each other, and a coupling portion 15 extending in the short-side direction X and connecting a lower direction Z2-side end portion of the leg portion 14 and a lower direction Z2-side end portion of the arm portion 16 to each other.

In the first terminal 10, a space surrounded by the leg portion 12, the coupling portion 13, and the leg portion 14 is filled with resin (housing 30). In other words, these portions are fixed by the long-side wall portion 31 of the housing 30. On the other hand, the arm portion 16 is not fixed by the housing 30, and is displaceable in the short-side direction X in the space 33a of the housing 30. Moreover, in the first terminal 10, a space surrounded by the leg portion 14, the coupling portion 15, and the arm portion 16 forms a receiving space 10a for receiving the terminal 50 of the plug connector 3.

On the other hand, the terminals 50 of the plug connector 3 are also provided in a pair so as to symmetrically face each other in the short-side direction X, and each terminal 50 has leg portions 52, 54 extending in the fitting direction Z and provided apart from each other along the short-side direction X, the mount portion 51 connected to a lower direction Z1-side end portion of the leg portion 52 and extending in the short-side direction X, and a coupling portion 53 extending in the short-side direction X and connecting the upper direction Z2-side end portion of the leg portion 52 and the upper direction Z2-side end portion of the leg portion 54 to each other. In the terminal 50, a space surrounded by the leg portion 52, the coupling portion 53, and the leg portion 54 is filled with resin (housing 70). In other words, these portions are fixed by the long-side wall portion 71 of the housing 70.

When the terminal 50 of the plug connector 3 is inserted into the receiving space 10a of the first terminal 10 of the receptacle connector 2, the terminal 50 contacts the leg portion 14 and the arm portion 16 forming the receiving space 10a. Specifically, the leg portion 14 of the first terminal 10 contacts the leg portion 52 of the terminal 50 at a contact point 14a on an outer wall surface facing the receiving space 10a, and the arm portion 16 of the first terminal 10 contacts the leg portion 54 of the terminal 50 at a contact point 16a on an outer wall surface facing the receiving space 10a. In this case, in the first terminal 10, the arm portion 16 is elastically deformed in the short-side direction X in the space 33a of the housing 30, while the leg portion 14 is fixed by the long-side wall portion 31 of the housing 30 and is therefore not deformed basically. At the same time as insertion of the terminal 50 into the receiving space 10a of the first terminal 10 as described above, the fitting raised portion 33 of the receptacle connector 2 is inserted into the fitting recessed portion 74 of the plug connector 3, and as a result, the receptacle connector 2 and the plug connector 3 are fitted in each other.

As shown in FIG. 7, the second terminals 20 of the receptacle connector 2 are provided in a pair so as to symmetrically face each other in the long-side direction Y. Each second terminal 20 has leg portions 22, 24 and an arm portion 26 extending in the fitting direction Z and provided apart from each other in this order along the long-side direction Y, the mount portion 21 connected to a lower direction Z2-side end portion of the leg portion 22 and extending in the long-side direction Y, a coupling portion 23 extending in the long-side direction Y and connecting an upper direction Z1-side end portion of the leg portion 22 and an upper direction Z1-side end portion of the leg portion 24 to each other, and a coupling portion 25 extending in the long-side direction Y and connecting a lower direction Z2-side end portion of the leg portion 24 and a lower direction Z2-side end portion of the arm portion 26 to each other.

In the second terminal 20, a space surrounded by the leg portion 22, the coupling portion 23, and the leg portion 24 is filled with resin (housing 30). In other words, these portions are fixed by the short-side wall portion 32 of the housing 30. On the other hand, the arm portion 26 is not fixed by the housing 30, and is displaceable in the long-side direction Y in the space 33b of the housing 30. Moreover, in the second terminal 20, a space surrounded by the leg portion 24, the coupling portion 25, and the arm portion 26 forms a receiving space 20a for receiving the terminal 60 of the plug connector 3.

On the other hand, the terminals 60 of the plug connector 3 are also provided in a pair so as to symmetrically face each other in the long-side direction Y, and each terminal 60 has leg portions 62, 64 extending in the fitting direction Z and provided apart from each other along the long-side direction Y, the mount portion 61 connected to a lower direction Z1-side end portion of the leg portion 62 and extending in the long-side direction Y, and a coupling portion 63 extending in the long-side direction Y and connecting an upper direction Z2-side end portion of the leg portion 62 and an upper direction Z2-side end portion of the leg portion 64 to each other. In the terminal 60, a space surrounded by the mount portion 61, the leg portion 62, the coupling portion 63, and the leg portion 64 is filled with resin (housing 70). In other words, these portions are fixed by the short-side wall portion 72 of the housing 70.

When the terminal 60 of the plug connector 3 is inserted into the receiving space 20a of the second terminal 20 of the receptacle connector 2, the terminal 60 contacts the leg portion 24 and the arm portion 26 forming the receiving space 20a. Specifically, the leg portion 24 of the second terminal 20 contacts the leg portion 64 of the terminal 60 at a contact point 24a on an outer wall surface facing the receiving space 20a, and the arm portion 26 of the second terminal 20 contacts the leg portion 62 of the terminal 60 at a contact point 26a on an outer wall surface facing the receiving space 20a. In this case, in the second terminal 20, the arm portion 26 is elastically deformed in the long-side direction Y in the space 33b of the housing 30, while the leg portion 24 is fixed by the short-side wall portion 32 of the housing 30 and is therefore not deformed basically. At the same time as insertion of the terminal 60 into the receiving space 20a of the second terminal 20 as described above, the fitting raised portion 33 of the receptacle connector 2 is inserted into the fitting recessed portion 74 of the plug connector 3.

Note that in the receptacle connector 2, the first terminal 10 and the second terminal 20 have the substantially same shape as clearly shown in FIGS. 6 and 7. Specifically, the mount portion 11, leg portion 12, coupling portion 13, leg portion 14, coupling portion 15, arm portion 16, and contact point 16a of the first terminal 10 correspond to the mount portion 21, leg portion 22, coupling portion 23, leg portion 24, coupling portion 25, arm portion 26, and contact point 26a of the second terminal 20. That is, the first terminal 10 and the second terminal 20 have a plurality of corresponding components, and these corresponding components have the substantially same shapes. In a relationship with the housing 30, the space surrounded by the leg portion 12, the coupling portion 13, and the leg portion 14 is filled with the housing 30 (resin) in the first terminal 10, and the space surrounded by the leg portion 22, the coupling portion 23, and the leg portion 24 is filled with the housing 30 (resin) in the second terminal 20. Also on this point, the first terminal 10 and the second terminal 20 have a common configuration. Note that the spaces in the first terminal 10 and the second terminal 20 are filled with the housing 30 (resin) as described above due to insert molding.

### Features and Effects

Next, features and effects of the receptacle connector 2 according to the present embodiment will be described.

In the present embodiment, the receptacle connector 2 includes a plurality of first terminals 10 formed so as to extend in the short-side direction X and arranged along the long-side direction Y, and the housing 30 having long-side wall portions 31 extending in the long-side direction Y so as to hold the plurality of first terminals 10. In the receptacle connector 2, a pair of first terminals 10 arranged apart from each other so as to face each other in the short-side direction X is provided, and the pairs of first terminals 10 are arranged along the long-side direction Y. The pairs of first terminals 10 are each held by a pair of long-side wall portions 31. The receptacle connector 2 further includes a pair of second terminals 20 formed so as to extend in the long-side direction Y, provided between the pairs of first terminals 10 and between the pair of long-side wall portions 31 in the short-side direction X, and arranged apart from each other so as to face each other in the long-side direction Y with the pairs of first terminals 10 interposed therebetween.

According to the present embodiment, the pair of second terminals 20 is provided at positions sandwiching the pairs of first terminals 10 in the long-side direction Y between the pairs of first terminals 10 in the short-side direction X, and therefore, the second terminals 20 can be properly provided using a space where the plurality of first terminals 10 is not provided in the receptacle connector 2. Thus, according to the present embodiment, the number of terminal pins can be properly increased without a size increase in the receptacle connector 2. Particularly, according to the present embodiment, the second terminals 20 are provided as the signal terminals, and therefore, the number of signal terminal pins can be properly increased.

In the present embodiment, the housing 30 has, at a portion surrounded by the pairs of first terminals 10 and the pair of second terminals 20, the fitting raised portion 33 provided for fitting the receptacle connector 2 in the plug connector 3 and having the substantially rectangular shape in plan view, and the tip end of each of the pair of second terminals 20 in the long-side direction Y extends to the edge of the fitting raised portion 33. Thus, the second terminals 20 can be properly provided using a space where the fitting raised portion 33 of the housing 30 is not provided in the receptacle connector 2.

In the present embodiment, the receptacle connector 2 further includes a plurality of third terminals 41 each formed so as to extend in the short-side direction X, provided in the vicinity of each of the pair of second terminals 20, and arranged apart from each other so as to face each other in the long-side direction Y with the pairs of first terminals 10 interposed therebetween. Thus, the other third terminals 41 can be properly provided further using a space where the plurality of first terminals 10 and the plurality of second terminals 20 are not provided in the receptacle connector 2.

In the present embodiment, the plurality of third terminals 41 includes two third terminals 41 arranged apart from each other so as to face each other in the short-side direction X with one second terminal 20 interposed therebetween. The receptacle connector 2 has, at a portion surrounded by the one second terminal 20 and the two third terminals 41, the fitting recessed portion 2a to be fitted in the fitting raised portion 3a of the plug connector 3, which has the substantially rectangular shape in plan view, and when the fitting raised portion 3a of the plug connector 3 is inserted into the fitting recessed portion 2a, the one second terminal 20 and the two third terminals 41 are elastically deformed by contacting the fitting raised portion 3a. In this case, the one second terminal 20 and the two third terminals 41 contact the three sides of the fitting raised portion 3a of the plug connector 3. Thus, elastic force (contact pressure) can be reliably applied from the one second terminal 20 and the two third terminals 41 to the fitting raised portion 3a of the plug connector 3, and therefore, the connectors can be fitted in each other.

In the present embodiment, the first terminal 10 and the second terminal 20 are the signal terminals, and the third terminal 41 is the power terminal. Thus, the first terminal 10 and the second terminal 20 can be used as the signal terminals while the third terminal 41 provided separately from the first terminal 10 and the second terminal 20 can be used as the power terminal.

In the present embodiment, the first terminal 10 forms the receiving space 10a for receiving the terminal 50 of the plug connector 3, and when the terminal 50 is inserted into the receiving space 10a, the arm portion 16 of the first terminal 10 forming the receiving space 10a is elastically deformed in the short-side direction X. The second terminal 20 forms the receiving space 20a for receiving the terminal 60 of the plug connector 3, and when the terminal 60 is inserted into the receiving space 20a, the arm portion 26 of the second terminal 20 forming the receiving space 20a is elastically deformed in the long-side direction Y. As described above, in the present embodiment, the first terminal 10 and the second terminal 20 different from each other in the elastic deformation direction upon fitting (the elastic deformation directions are perpendicular to each other) can be properly provided in the receptacle connector 2. Note that the receiving space 10a of the first terminal 10 may be referred to as a first receiving space and the receiving space 20a of the second terminal 20 may be referred to as a second receiving space.

### Modifications

In the above-described embodiment, the receptacle connector 2 has the pair of second terminals 20 arranged so as to face each other in the long-side direction Y with the pairs of first terminals 10 interposed therebetween, but in a modification, pairs of second terminals 20 may be provided. In this case, a plurality of (e.g., two or three) second terminals 20 arranged along the short-side direction X simply needs to be provided in each of the pair of short-side wall portions 32 of the housing 30 of the receptacle connector 2. Thus, the number of signal terminal pins can be further increased.

In the above-described embodiment, the third terminal 41 is used as the power terminal, but in a modification, the third terminal 41 may be used as a signal terminal. In another modification, the third terminal 41 may be used as a ground terminal.

The above-described embodiment is an example for describing the present disclosure, and the present disclosure is not limited thereto. The present disclosure can be implemented in various forms without departing from the gist thereof.

The electric connector according to the present disclosure can be used for, e.g., connecting boards through a flat cable in electronic equipment for high-speed electric signal transmission, such as a smartphone or a mobile phone.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An electric connector comprising:
a first terminal;
a second terminal; and
a housing,
wherein the first terminal is formed so as to extend in a short-side direction of the electric connector, and the second terminal is formed so as to extend in a long-side direction of the electric connector,
a pair of the first terminals is provided so as to face each other in the short-side direction and the pairs of the first terminals are arranged along the long-side direction,
a pair of the second terminals is provided so as to face each other in the long-side direction,
the housing has a pair of wall portions, and the pair of wall portions extends in the long-side direction, faces each other in the short-side direction, and holds the pairs of the first terminals, and
the pair of the second terminals is provided between the pairs of the first terminals and between the pair of wall portions in the short-side direction, and is provided so as to sandwich the pairs of the first terminals in the long-side direction.

2. The electric connector according to claim 1, wherein
the housing further has a fitting raised portion,
the fitting raised portion is provided at a portion surrounded by the pairs of the first terminals and the pair of the second terminals, and
each of the pair of the second terminals has a tip end in the long-side direction, which extends to an edge of the fitting raised portion.

3. The electric connector according to claim 1, further comprising:
a plurality of third terminals,
wherein each of the plurality of third terminals is formed so as to extend in the short-side direction, and
the plurality of third terminals is provided so as to face each other in the short-side direction with each of the pair of the second terminals interposed therebetween and to face each other in the long-side direction with the pairs of the first terminals interposed therebetween.

4. The electric connector according to claim 3, further comprising:
a fitting recessed portion,
wherein the fitting recessed portion is provided at a portion surrounded by each of the pair of the second terminals and the third terminals facing each other in the short-side direction with the each of the pair of the second terminals interposed therebetween, and
the pair of the second terminals and the third terminals facing each other in the short-side direction with each of the pair of the second terminals interposed therebetween are elastically deformed when the electric connector and a partner connector are fitted in each other.

5. The electric connector according to claim 3, wherein
the first terminal and the second terminal are signal terminals, and
the third terminals are power terminals or ground terminals.

6. The electric connector according to claim 1, wherein
each of the pair of the second terminals includes a plurality of the second terminals arranged along the short-side direction.

7. The electric connector according to claim 1, wherein
the first terminal has a first receiving space for receiving a terminal of a partner connector, and when the terminal of the partner connector is inserted into the first receiving space, part of the first terminal forming the first receiving space is elastically deformed in the short-side direction, and
the second terminal has a second receiving space for receiving a terminal of the partner connector, and when the terminal of the partner connector is inserted into the second receiving space, part of the second terminal forming the second receiving space is elastically deformed in the long-side direction.

8. The electric connector according to claim 1, wherein
the first terminal and the second terminal have a substantially identical shape, and are formed integrally with the housing by insert molding.

9. A connector assembly comprising:
a first connector which is the electric connector according to claim 1; and
a second connector fittable in the first connector,
wherein the second connector has a plurality of terminals to be electrically connected to the first terminal and the second terminal of the first connector.
